(19) United States
(12) Patent Application Publication
(10) Pub. No.: US 2016/0343466 A1
(43) Pub. Date: Nov. 24, 2016

(54) MULTI-LAYER SYNTHETIC GRAPHITE CONDUCTOR

(71) Applicant: Jones Tech (USA), Inc., Cupertino, CA (US)

(72) Inventor: Xiaoning Wu, Beijing (CN)

(21) Appl. No.: 14/716,877

(22) Filed: May 20, 2015

(51) Int. Cl. H01B 5/00; B32B 38/00; H01B 1/04; B32B 18/00; B32B 3/08; B32B 7/12; B32B 37/18; B32B 37/14

(52) U.S. Cl. CPC H01B 5/002; B32B 37/18; B32B 38/0004; B32B 37/144; B32B 18/00; B32B 3/08; B32B 7/12; H01B 1/04; B32B 2307/302; B32B 2307/202; B32B 2313/04; B32B 2457/00; C04B 2237/363

(57) ABSTRACT

A multi-layer synthetic graphite conductor, including: forming a body of the synthetic graphite conductor comprising multiple layers of a synthetic graphite sheet; and forming at least one structure through the layers for maintaining a high thermal conductivity by enabling high thermal conduction between the layers.

### BACKGROUND

Sheets of thermally conductive material can be employed as thermal conductors in a wide variety of electronic devices. For example, a sheet of synthetic graphite can be used to spread heat in a hand-held electronic device. A sheet of synthetic graphite can be used to transfer heat away from hot spots in an electronic device as well as perform heat transfer between components of an electronic device.

The heat energy transferred by a sheet of synthetic graphite can be proportional to the thickness of the sheet or the cross section area. Higher power higher clock speed electronic devices can generate more heat energy and require thicker synthetic graphite. However, an increase in the thickness of a sheet synthetic graphite can reduce its thermal conductivity. This can severely limit the usefulness of synthetic graphite for high power high speed electronic devices, e.g. for electronic devices requiring a sheet of synthetic graphite greater then 40 micrometers with a thermal conductivity greater than 1000 watts per meter-kelvin.

### SUMMARY

In general, in one aspect, the invention relates to a multi-layer synthetic graphite conductor at any thickness. The synthetic graphite conductor can include: a body comprising multiple layers of a synthetic graphite sheet; and at least one structure formed through the layers for maintaining a high thermal conductivity by enabling high thermal conduction between the layers.

In general, in another aspect, the invention relates to a method for forming a multi-layer synthetic graphite conductor at any thickness. The method can include: forming a body of the synthetic graphite conductor comprising multiple layers of a synthetic graphite sheet; and forming at least one structure through the layers for maintaining a high thermal conductivity by enabling high thermal conduction between the layers.

Other aspects of the invention will be apparent from the following description and the appended claims.

### BRIEF DESCRIPTION OF THE DRAWINGS

Embodiments of the present invention are illustrated by way of example, and not by way of limitation, in the figures of the accompanying drawings and in which like reference numerals refer to similar elements.

FIGS. 1A-1C illustrate a multi-layer synthetic graphite conductor including a rectangular island structure that maintains a high thermal conductivity in one or more embodiments.

FIGS. 2A-2B illustrate a multi-layer synthetic graphite conductor including a conical island structure that maintains a high thermal conductivity in one or more embodiments.

FIGS. 3A-3B illustrate a multi-layer synthetic graphite conductor including a metal plating structure that maintains a high thermal conductivity in one or more embodiments.

FIG. 4 illustrates a multi-layer synthetic graphite conductor including multiple structures that maintain a high thermal conductivity in one or more embodiments.

FIG. 5 illustrates a multi-layer synthetic graphite conductor in one or more embodiments that provides a flexible body.

FIG. 6 illustrates a multi-layer synthetic graphite conductor in one or more embodiments that provides a star topology with multiple branches.

FIG. 7 illustrates a method for forming a multi-layer synthetic graphite conductor in one or more embodiments.

### DETAILED DESCRIPTION

Reference will now be made in detail to the various embodiments of the present disclosure, examples of which are illustrated in the accompanying drawings. Like elements in the various figures are denoted by like reference numerals for consistency. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, have not been described in detail so as not to unnecessarily obscure aspects of the present disclosure.

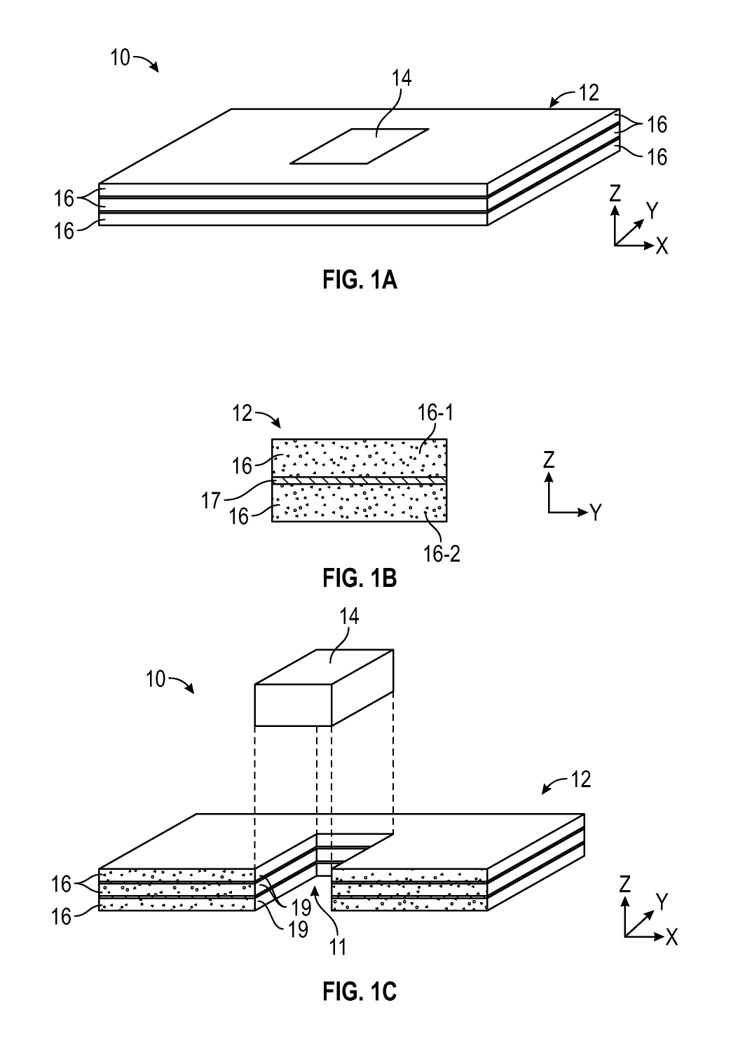

FIG. 1A is a perspective view of a multi-layer synthetic graphite conductor 10 with high conductivity in one or more embodiments. The synthetic graphite conductor 10 includes a body 12 having multiple layers 16 of a synthetic graphite sheet and further includes an island structure 14 formed through the layers 16. The island structure 14 maintains a high thermal conductivity for the synthetic graphite conductor 10 by enabling high thermal conduction between the layers 16.

Each layer 16 in the body 12 enables high thermal conduction in at least one horizontal x-y dimension of the body 12. The island structure 14 enables high thermal conduction through a z dimension of the body 12. The island structure 14 can be formed from a material having high thermal conductivity, e.g., copper, silver, other metals, metal alloys, etc. The island structure 14 can be formed from a thermal compound.

There can be any number of the layers 16 in the body 12. The high thermal conductivity vertically through the layers 16 provided by the island structure 14, and other structures disclosed herein, effectively eliminate any upper limit on the thickness in the vertical z direction of the synthetic graphite conductor 10.

In one or more embodiments, the body 12 can include a set of intervening bonding layers between the layers 16. FIG. 1B is a cross-sectional view of the body 12 showing an intervening bonding layer 17 between a layer 16-1 and a layer 16-2 of the layers 16. The intervening bonding layer 17 can be a pressure sensitive adhesive, an adhesive resin, etc. The intervening bonding layers in the body 12 can be formed of a flexible bonding material to allow flexing of the body 12.

FIG. 1C is an exploded cross-sectional view of the synthetic graphite conductor 10 showing a substantially rectangular opening 11 formed through the layers 16. The opening 11 can be cut through the layers 16 to accommodate the substantially rectangular shape and dimensions of the island structure 14. The opening 11 exposes edges of each of the layers 16, e.g. the edges 19 of the layers 16. The exposed edges 19 can enable thermal coupling between the layers 16 and the island structure 14.

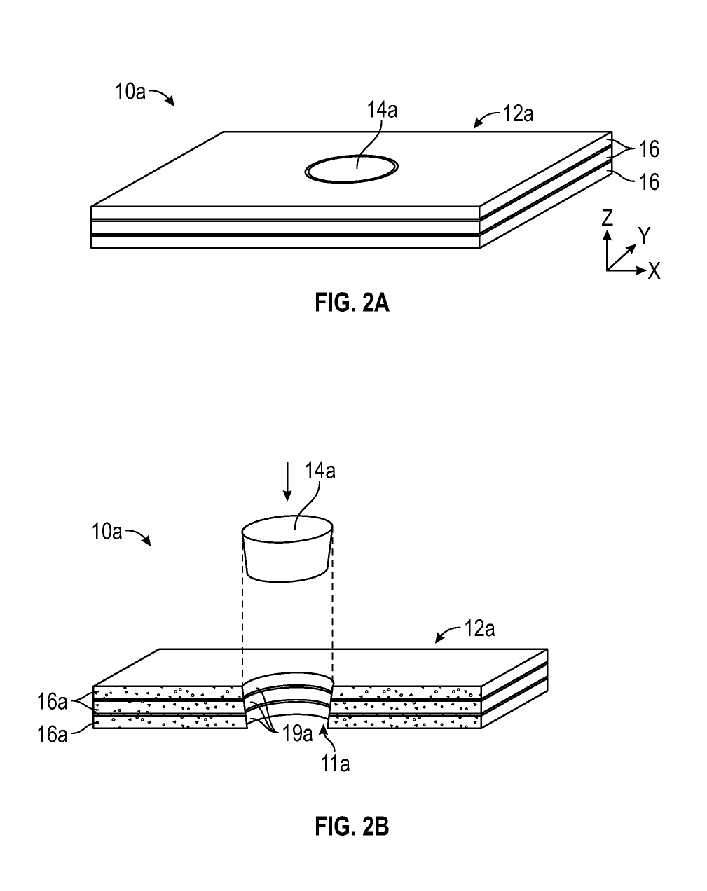

FIGS. 2A-2B are perspective and exploded cross-sectional views, respectively, of a multi-layer synthetic graphite conductor 10a with high conductivity in one or more embodiments. The synthetic graphite conductor 10a includes a body 12a having multiple layers 16a of a synthetic graphite sheet and further includes an island structure 14a formed through the layers 16a that maintains a high thermal conductivity of the synthetic graphite conductor 10a by enabling high thermal conduction between the layers 16a. An opening 11a cut through the layers 16a accommodates the substantially conical shape and dimensions of the island structure 14a. The opening 11a exposes edges of each of the layers 16a, e.g. the edges 19a. The exposed edges 19a can enable thermal coupling between the layers 16a and the island structure 14a.

Each layer 16a enables thermal conduction in at least one horizontal x-y dimension of the body 12a. There can be any number of the layers 16a in the body 12. The body 12a can include intervening bonding layers between the layers 16a. The island structure 14a enables high thermal conduction through a z dimension of the body 12a. The island structure 14a can be formed from a material having a high thermal conductivity, e.g., copper, silver, other metals, metal alloys, a thermal compound etc.

The high thermal conductivity of the multi-layer synthetic graphite conductor 10a can be estimated as

K·τ/(τ+σ)

where K is the thermal conductivity of one of the layers 16a, τ is the thickness of each layer 16a, and σ is the thickness of any intervening bonding layers.

In one or more embodiments, the ratio of the perimeter of the top, larger, surface of the island structure 14a to the perimeter of the bottom surface of the island structure 14a can be approximately 1.1.

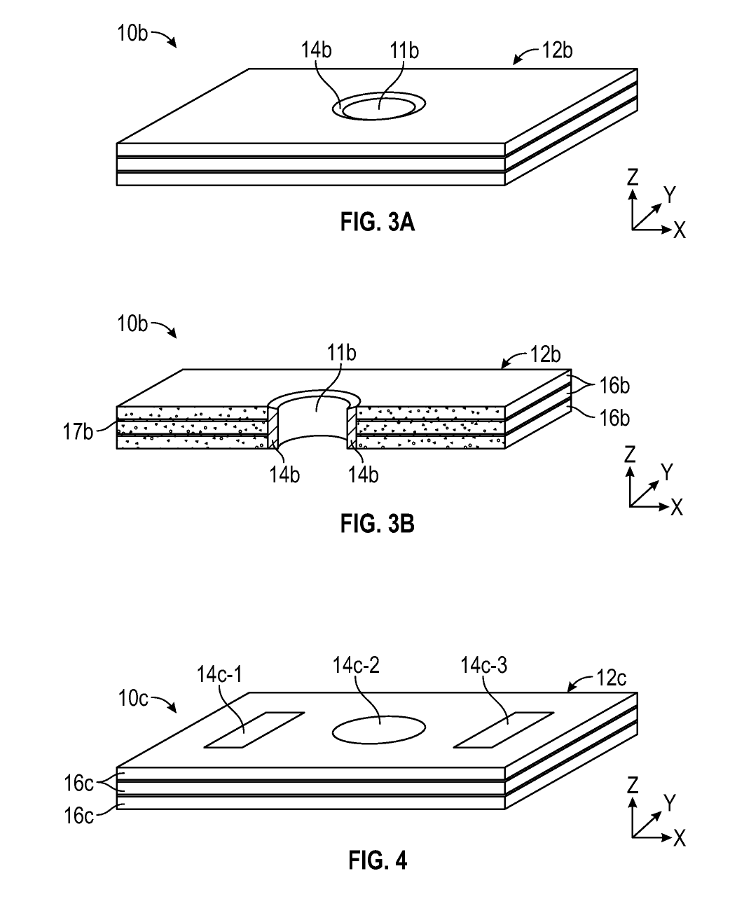

FIGS. 3A-3B are perspective and exploded cross-sectional views, respectively, of a multi-layer synthetic graphite conductor 10b with high conductivity in one or more embodiments. The synthetic graphite conductor 10b includes a body 12b having multiple layers 16b of a synthetic graphite sheet and further includes a plating structure 14b formed in an opening 11b through the layers 16b that maintains a high thermal conductivity of the synthetic graphite conductor 10b by enabling thermal conduction between the layers 16b. The opening 11b can be cut through the layers 16b to accommodate formation of the plating structure 14b. The opening 11b exposes edges of each of the layers 16b and enables thermal coupling between the layers 16b via the plating structure 14b.

Each layer 16b enables thermal conduction in at least one horizontal x-y dimension of the body 12b. There can be any number of the layers 16b in the body 12b. The body 12b can include intervening bonding layers between the layers 16b, e.g., a bonding layer 17b. The plating structure 14b enables high thermal conduction through a z dimension of the body 12b. The plating structure 14b can be a copper plating, a silver plating, a metal alloy plating, a thermal compound plating, etc.

FIG. 4 is a perspective view of a multi-layer synthetic graphite conductor 10c with high conductivity in one or more embodiments. The synthetic graphite conductor 10c includes a body 12c having multiple layers 16c of a synthetic graphite sheet and further includes multiple structures 14c-1, 14c-2, and 14c-3 formed through the layers 16c that maintain a high thermal conductivity of the synthetic graphite conductor 10c by enabling high thermal conduction between the layers 16c. Respective openings can be cut through the layers 16c to accommodate structures 14c-1, 14c-2, and 14c-3. The openings through the layers 16c expose edges of each of the layers 16c and enable thermal coupling between the layers 16c via the structures 14c-1, 14c-2, and 14c-3.

Each layer 16c enables thermal conduction in at least one horizontal x-y dimension of the body 12c. There can be any number of the layers 16c in the body 12c. The body 12c can include intervening bonding layers between the layers 16c. The structures 14c-1, 14c-2, and 14c-3 enable thermal conduction through a z dimension of the body 12c. The structures 14c-1, 14c-2, and 14c-3 can be any combination of island structures and plating structures of copper, silver, metal alloy, thermal compound, etc.

The x and y dimensions of the body 12c can be cut and the z dimension of the body 12c can be selected in response to the dimensional specifications of an electronic device into which the body 12c is adapted to fit. The x and y coordinates of the structures 14c-1, 14c-2, and 14c-3 can correspond to the heat flow requirements of an electronic device. For example, the positions of the structures 14c-1, 14c-2, and 14c-3 can correspond to the positions of heat producing elements of an electronic device or can be based on the positions of desired heat paths inside the electronic device.

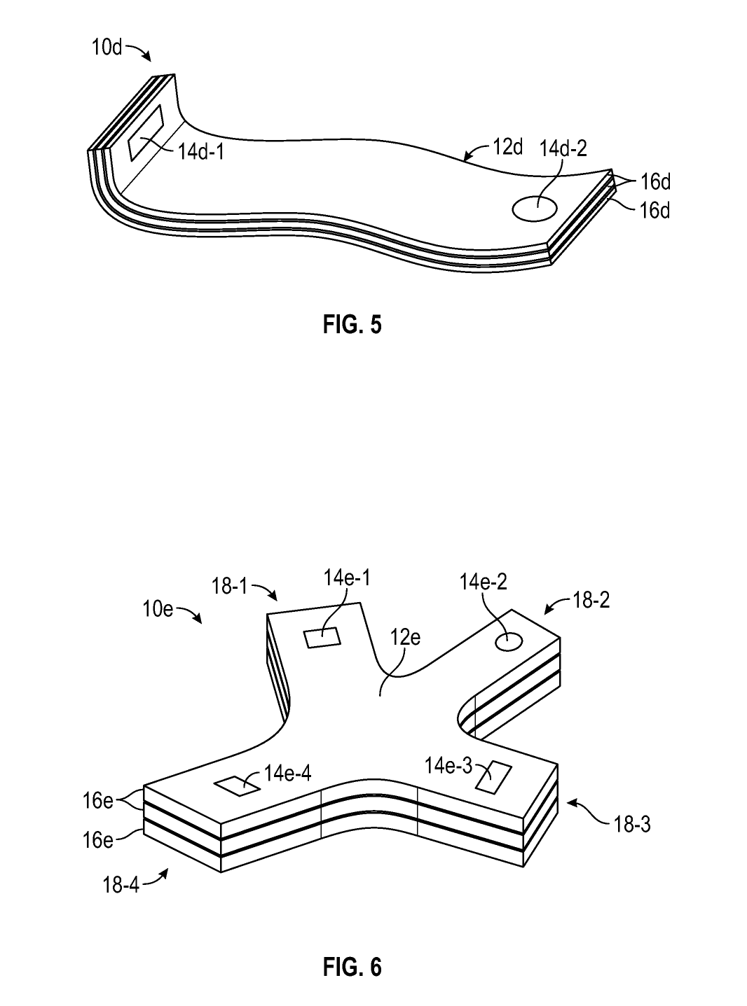

FIG. 5 is a perspective view of a multi-layer synthetic graphite conductor 10d with high conductivity in one or more embodiments. The synthetic graphite conductor 10d includes a flexible body 12d having multiple layers 16d of a synthetic graphite sheet and further includes a pair of structures 14d-1, 14d-2, formed through the layers 16d that maintain a high thermal conductivity of the synthetic graphite conductor 10d by enabling high thermal conduction between the layers 16d. Respective openings can be cut through the layers 16d to accommodate structures 14d-1, 14d-2. The openings through the layers 16d expose edges of each of the layers 16d and enable thermal coupling between the layers 16d via the structures 14d-1, 14d-2.

Each layer 16d enables thermal conduction through the length and width of the curved body 12d. The layers 16d can include intervening bonding layers that enable flexing of the body 12d. There can be any number of the layers 16d. The structures 14d-1, 14d-2 can be any combination of island structures and plating structures of copper, silver, metal alloy, thermal compound, etc.

The body 12d can be cut and flexed to fit the dimensional specifications of an electronic device into which the body 12d will be installed. The positions of the structures 14d-1, 14d-2 can correspond to the heat flow requirements of an electronic device.

FIG. 6 is a perspective view of a multi-layer synthetic graphite conductor 10e with high conductivity in one or more embodiments. The synthetic graphite conductor 10e includes a body 12e having multiple layers 16e of a synthetic graphite sheet and cut into a star shape with a set of branches 18-1 through 18-4. The synthetic graphite conductor 10e further includes a set of respective structures 14e-1 through 14e-4 formed in the branches 18-1 through 18-4. The structures 14e-1 through 14e-4 maintain a high thermal conductivity of the synthetic graphite conductor 10e by enabling high thermal conduction between the layers 16e. Respective openings can be cut through the branches 18-1 through 18-4 to accommodate structures 14e-1 through 14e-4. The openings in the branches 18-1 through 18-4 expose edges of each of the layers 16e and enable thermal coupling between the layers 16e via the structures 14e-1 through 14e-4.

Each layer 16e enables thermal conduction through the body 12 including the branches 18-1 through 18-4. The layers 16e can include intervening bonding layers. The intervening bonding layers can enable flexing of the branches 18-1 through 18-4. There can be any number of the layers 16e. The structures 14e-1 through 14e-4 can be any combination of island structures and plating structures of copper, silver, metal alloy, thermal compound, etc.

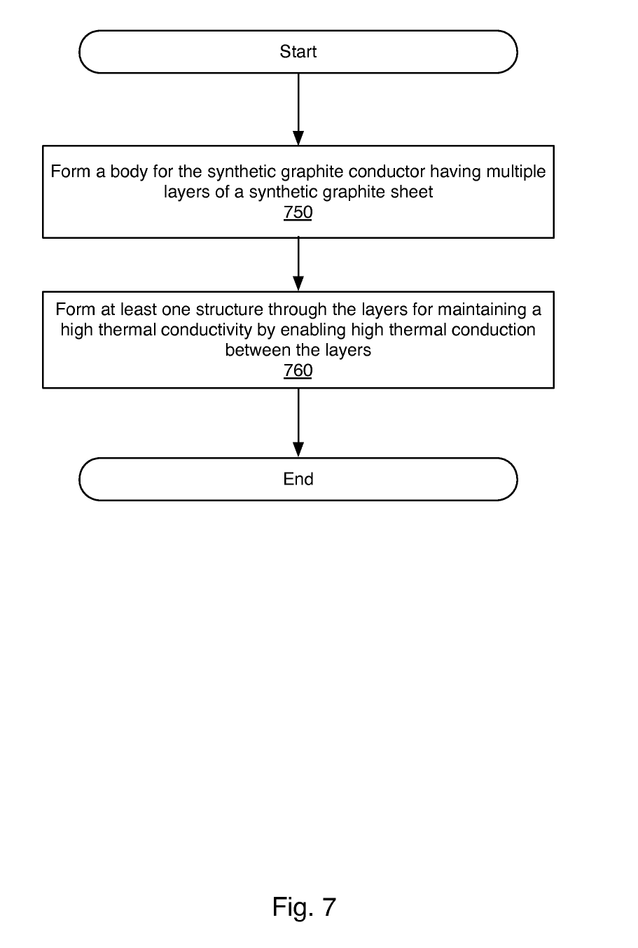

FIG. 7 illustrates a method for forming a multi-layer synthetic graphite conductor in one or more embodiments. While the various steps in this flowchart are presented and described sequentially, one of ordinary skill will appreciate that some or all of the steps can be executed in different orders and some or all of the steps can be executed in parallel. Further, in one or more embodiments, one or more of the steps described below can be omitted, repeated, and/or performed in a different order. Accordingly, the specific arrangement of steps shown in FIG. 7 should not be construed as limiting the scope of the invention.

At step 750, a body of the synthetic graphite conductor is formed having multiple layers of a synthetic graphite sheet. Step 750 can include cutting the layers from the synthetic graphite sheet and laminating the layers with intervening layers of bonding material. The dimensions and shape of the cuts and the number of layers can be adapted to fit the synthetic graphite conductor in a space allocated inside an electronic device.

At step 760, at least one structure is formed through the layers of the synthetic graphite conductor for maintaining a high thermal conductivity by enabling high thermal conduction between the layers. Step 760 can include cutting an opening through the layers and filling it with a melted metal insert, metal plating, solder, thermal compound, etc. Step 760 can include cutting the opening at a position on the body that corresponds to a heat transfer requirement of an electronic device.

While the foregoing disclosure sets forth various embodiments using specific diagrams, flowcharts, and examples, each diagram component, flowchart step, operation, and/or component described and/or illustrated herein may be implemented, individually and/or collectively, using a range of processes and components.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While the invention has been described with respect to a limited number of embodiments, those skilled in the art, having benefit of this disclosure, will appreciate that other embodiments may be devised which do not depart from the scope of the invention as disclosed herein.

What is claimed is:

1. A synthetic graphite conductor, comprising:
a body comprising multiple layers of a synthetic graphite sheet; and
at least one structure formed through the layers for maintaining a high thermal conductivity by enabling high thermal conduction between the layers.

2. The synthetic graphite conductor of claim 1, wherein the structure comprises an island structure formed through the layers such that the island structure provides thermal coupling among the layers.

3. The synthetic graphite conductor of claim 2, wherein the island structure fills an opening formed through the layers such that the island structure thermally couples to a set of edges of the layers exposed by the opening.

4. The synthetic graphite conductor of claim 2, wherein the island structure has a substantially rectangular shape.

5. The synthetic graphite conductor of claim 2, wherein the island structure has a substantially conical shape.

6. The synthetic graphite conductor of claim 1, wherein the structure comprises a metal plating applied to an opening formed through the layers such that the metal plating thermally couples to a set of edges of the layers exposed by the opening.

7. The synthetic graphite conductor of claim 1, wherein the body includes a set of intervening bonding layers between the layers.

8. The synthetic graphite conductor of claim 7, wherein the intervening bonding layers enable flexing of the body of the synthetic graphite conductor.

9. The synthetic graphite conductor of claim 1, wherein the body has a star pattern including a set of branches such that at least one of the branches includes the structure.

10. The synthetic graphite conductor of claim 1, wherein the structure is positioned in the body to correspond to a position of at least one thermal component in an electronic device for which the synthetic graphite conductor is adapted.

11. A method for forming a synthetic graphite conductor, comprising:
forming a body of the synthetic graphite conductor comprising multiple layers of a synthetic graphite sheet; and
forming at least one structure through the layers for maintaining a high thermal conductivity by enabling high thermal conduction between the layers.

12. The method of claim 11, wherein forming at least one structure comprises forming an island structure through the layers such that the island structure provides thermal coupling among the layers.

13. The method of claim 12, wherein forming an island structure comprises forming an opening through the layers and filling the opening with a material that thermally couples to a set of edges of the layers exposed by the opening.

14. The method of claim 12, wherein forming an island structure comprises forming an island structure having a substantially rectangular shape.

15. The method of claim 12, wherein forming an island structure comprises forming an island structure having a substantially conical shape.

16. The method of claim 11, wherein forming at least one structure comprises forming an opening through the layers and applying a metal plating that thermally couples to a set of edges of the layers exposed by the opening.

17. The method of claim 11, wherein forming a body comprises forming a set of intervening bonding layers between the layers.

18. The method of claim 17, wherein forming a set of intervening bonding layers comprises forming a set of intervening bonding layers that enable flexing of the body of the synthetic graphite conductor.

19. The method of claim 11, wherein forming a body comprises forming a star pattern including a set of branches and wherein forming at least one structure comprises forming the structure through at least one of the branches.

20. The method of claim 11, wherein forming at least one structure comprises positioning the structure in the body to correspond to a position of at least one thermal component in an electronic device for which the synthetic graphite conductor is adapted.
